(19) United States
(12) Patent Application Publication
(10) Pub. No.: US 2004/0096051 A1
(43) Pub. Date: May 20, 2004

(54) Remote power controller and method of controlling the same

(75) Inventors: Kyoung-Won Kim, Yongin city (KR); Houn-Soo Kim, Yongin city (KR); Sang-Jin Lee, Suwon city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon city (KR)

(21) Appl. No.: 10/681,234

(22) Filed: Oct. 9, 2003

(30) Foreign Application Priority Data
Nov. 18, 2002 (KR) 2002-71598

(51) Int. Cl. H04M 1/00; H04M 3/00

(52) U.S. Cl. 379/373.01

(57) ABSTRACT

A remote power controller and a method of controlling the same, which can distinguish between a telephone call to speak with a person and a telephone call to enable an electronic device.

### CROSS-REFERENCE TO RELATED APPLICATIONS

This application claims the benefit of Korean Patent Application No. 2002-71598, filed Nov. 18, 2002, in the Korean Intellectual Property Office, the disclosure of which is incorporated herein by reference.

### BACKGROUND OF THE INVENTION

1. Field of the Invention

The present invention relates to a remote power controller and a method of controlling the same, and, more particularly, to a remote power controller and a method of controlling the same, which remotely turns on an electronic device through a PSTN (public switched telephone network).

2. Description of the Related Art

Recently, various technology has been developed to remotely control a plurality of electronic devices in different locations. For example, there is technology that enables the plurality of electronic devices in different locations by remotely controlling power of the electronic devices.

In a field of a computer system, because the computer systems are widely spread, there has been developed technology that links the computer systems in different locations to each other via the Internet, so that one computer system can have access to another computer system. Together with the development of computer networking technologies, it is easy to interchange data among the computer systems that are remotely located one another without costing much money or much time.

In addition, because it is possible to access a remote computer system only when its power is enabled, the computer network requires remote power control technology.

As conventional remote power control technology, there has been proposed a method of remotely enabling the computer system by using a ring signal transmitted through the PSTN. In the state that the remote computer system is connected to the PSTN with its modem, when a user calls a remote telephone connected to the remote computer system through the PSTN, the modem of the remote computer system detects the ring signal transmitted through the PSTN, thereby enabling the remote computer system.

However, in the conventional remote power control method, when a user reaches a remote telephone that is connected to the remote computer system, it is impossible to distinguish between a telephone call to speak to a person and a telephone call to enable the remote computer system. Therefore, when a user calls the remote telephone to speak to a person, the ring signal enables the remote computer system. Conversely, when a user calls the remote telephone to enable the remote computer system, the ring signal rings a bell of the remote telephone.

### SUMMARY OF THE INVENTION

Accordingly, it is an aspect of the present invention to provide a remote power controller and a method of controlling the same, which can distinguish between a telephone call to speak to a person and a telephone call to enable an electronic device.

Additional aspects and/or advantages of the present invention will be set forth in part in the description that follows and, in part, will be obvious form the description, or may be learned by practicing the present invention.

The foregoing and/or other aspects of the present invention are achieved by providing a remote power controller to enable an electronic device, comprising a power-on signal generator, which is electrically connected to the electronic device, to generate a power-on signal to enable the electronic device; and a control part to compare a caller ID with a predetermined ID when the caller ID (identification) and a ring signal are received through a PSTN (public switched telephone network), to control the power-on signal generator to generate the power-on signal when the caller ID is identical to the predetermined ID, and to control the ring signal to be transmitted to a telephone when the caller ID is different from the predetermined ID.

According to an aspect of the invention, the remote power controller further comprises a first switching part that is electrically connected to the telephone to control the ring signal being transmitted to the telephone.

According to an aspect of the invention, the control part enables the first switching part when the caller ID is different from the predetermined ID.

According to an aspect of the invention, the remote power controller further comprises an on-hook sensor to determine whether the telephone is on-hook when the first switching part is enabled, and to transmit a first determination to the control part.

According to an aspect of the invention, the remote power controller further comprises an off-hook sensor to determine whether the telephone is off-hook and to transmit a second determination to the control part; and a second switching part to open and close an electrical connection between the telephone and the off-hook sensor.

According to an aspect of the invention, the control part enables the first switching part and disables the second switching part when the off-hook sensor determines that the telephone is off-hook.

According to an aspect of the invention, the control part disables the first switching part and enables the second switching part when the on-hook sensor determines that the telephone is on-hook.

According to an aspect of the invention, the remote power controller further comprises a ring signal cut-off part that is controlled by the control part, to cut off reception of the ring signal when the caller ID is identical to the predetermined ID.

According to an aspect of the invention, the remote power controller further comprises a signal reception detector to detect reception of the caller ID and the ring signal, and to transmit the caller ID and the ring signal to the control part.

According to an aspect of the invention, the remote power controller further comprises a connection ID generator that is controlled by the control part, to generate a connection ID that is identical to the caller ID when the caller ID is different from the predetermined ID and to transmit the connection ID to the telephone.

According to another aspect of the present invention, the foregoing and other aspects may be achieved by providing a method of controlling a remote power controller to turn on an electronic device, comprising: receiving a caller ID and a ring signal through a PSTN; comparing the caller ID with a predetermined ID; and controlling the electronic device to be enabled when the caller ID is identical to the predetermined ID, and controlling the ring signal to be transmitted to a telephone when the caller ID is different from the predetermined ID.

According to an aspect of the invention, the controlling comprises cutting off reception of the ring signal when the caller ID is identical to the predetermined ID.

According to an aspect of the invention, the controlling comprises generating a connection ID that is identical to the caller ID when the caller ID is different from the predetermined ID, and transmitting the connection ID to the telephone.

According to an aspect of the invention, the controlling comprising preventing the ring signal from being transmitted to the telephone when the caller ID is identical to the predetermined ID.

According to an aspect of the invention, the method further comprises determining whether the telephone is on-hook, and wherein the controlling comprises opening an electric connection between the telephone and the PSTN when the telephone is on-hook.

According to an aspect of the invention, the method further comprises determining whether the telephone is off the hook, and wherein the controlling comprises connecting the telephone to the PSTN when the telephone is off-hook.

According to an aspect of the invention, the method further comprises setting up the predetermine ID.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 illustrates a remote power control system using a remote power controller according to an embodiment of the present invention;

FIG. 2 is a control block diagram of the remote power controller;

FIG. 3 is a control flowchart of the remote power controller shown in FIG. 1 when it receives a caller ID and a ring signal; and

FIG. 4 is a control flowchart of the remote power controller shown in FIG. 1 when a remote telephone is off the hook.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

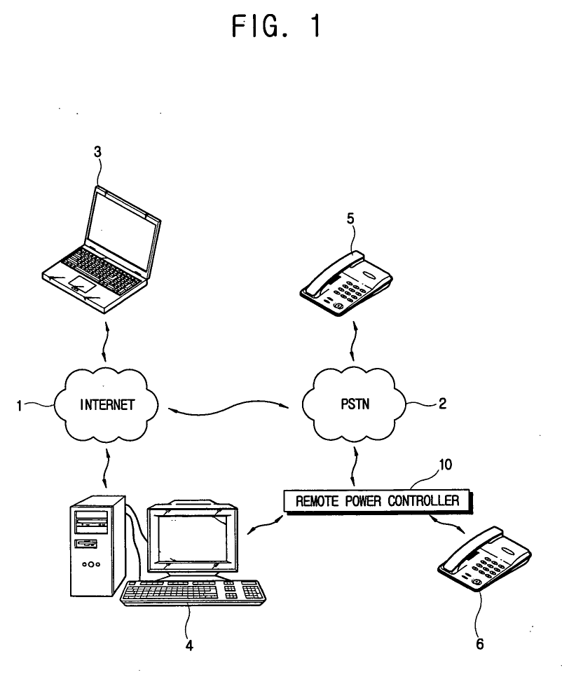

FIG. 1 illustrates a remote power control system using a remote power controller according to the present invention. As shown in FIG. 1, a remote power control system according to the present invention comprises a computer system 4 in a remote location (hereinafter, referred to as “remote computer”) to which a user wants to access, a local computer 3 connected to the remote computer 4 through Internet 1, a local telephone 5 and a remote telephone 6 connected to each other through a PSTN 2, and a remote power controller 10 controlling the remote computer 4 and the remote telephone 6 on the basis of a caller ID (identification) and a ring signal received by the remote telephone 6 through the PSTN 2.

When a user wants to access the remote computer system 4 using the local computer system 3, a user calls the remote telephone 6 using the local telephone 5 through the PSTN 2 in order to enable the remote computer system 4. At this time, the remote power controller 10 receives the caller ID and the ring signal of the local telephone 5 through the PSTN 2, and compares the caller ID with a predetermined ID set up in advance, thereby controlling the remote computer system 4 to be turned on or the remote telephone 6 to ring a bell. Herein, the local telephone 5 is employed for reaching the remote telephone 6 connected to the remote computer system 4, and comprises a wired telephone, a radiotelephone, a portable telephone, a modem equipped in a computer, etc., which use the PSTN 2.

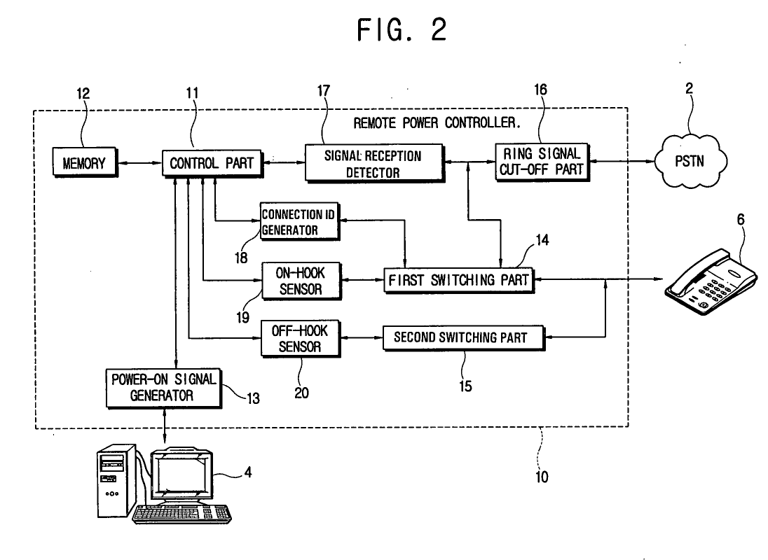

FIG. 2 is a control block diagram of the remote power controller 10. As shown therein, the remote power controller 10 comprises a power-on signal generator 13 that is electrically connected to the remote computer system 4 to generate a power-on signal to enable the remote computer system 4; and a control part 11 to compare the caller ID with the predetermined ID when the caller ID and the ring signal are received through the PSTN 2, to control the power-on signal generator 13 to generate the power-on signal when the caller ID is identical with the predetermined ID, and to control the ring signal to be transmitted to the remote telephone 6 when the caller ID is different from the predetermined ID.

The power-on signal generator 13 is controlled to generate the power-on signal by the control part 11 when the control part 11 determines that the caller ID is identical to the predetermined ID. The power-on signal generated by the power-on signal generator 13 is transmitted to the remote computer system 4, thereby enabling the remote computer system 4.

In an embodiment, the caller ID received through the PSTN 2 means a phone number of the local telephone 5 transmitted when a user reaches the remote telephone 6 by the local telephone 5. Further, in an embodiment, the ring signal means a control signal to ring the bell of the remote telephone 6.

In an embodiment, the predetermined ID means a phone number set up in advance by a user, and is stored in a memory 12. Herein, the remote power controller 10 further comprises an ID setup part (not shown) for setting up the predetermined ID. The ID setup part can include various input units which are well known, and therefore their descriptions will be omitted.

The control part 11 compares the caller ID received through the PSTN 2 with the predetermined ID stored in the memory 12, and controls the power-on signal generator 13 to generate the power-on signal when the caller ID is identical with the predetermined ID, thereby turning on the remote computer system 4.

Conversely, when the caller ID received through the PSTN 2 is different from the predetermined ID stored in the memory 12, the control part 11 determines that a user intends to reach the remote telephone 6 in order to talk with a person, and transmits the ring signal received through the PSTN 2 to the remote telephone 6, thereby ringing the bell of the remote telephone 6.

Further, the remote power controller 10 includes a first switching part 14 controlling the ring signal being transmitted to the remote telephone 6. When the remote telephone 6 is on the hook, the first switching part 14 is turned off, i.e., on standby state before receiving the ring signal through the PSTN 2, thereby preventing the ring signal received through the PSTN 2 from being transmitted to the remote telephone 6. When the caller ID is different from the predetermined ID, the control part 11 enables the first switching part 14, thereby transmitting the ring signal to the remote telephone 6 and ringing the bell. Thus, only when the caller ID identical to the predetermined ID is received through the PSTN 2, the remote computer 4 is enabled without ringing the bell of the remote telephone 6.

Further, the remote power controller 10 includes an on-hook sensor 19 sensing that the remote telephone 6 is on the hook. The on-hook sensor 19 senses when the remote telephone 6 is put on the hook (for example, when a user hangs up the receiver) converted from on-hook state (for example, when a user hangs on the receiver). When the on-hook sensor 19 senses that the remote telephone 6 is on the hook, the control part 11 disables the first switching part 14, thereby being in the standby state for receiving the ring signal.

Further, the remote power controller 10 includes an off-hook sensor 20 sensing that the remote telephone 6 is off the hook. In a standby state before receiving the ring signal, when the off-hook sensor 20 determines that the remote telephone 6 is off the hook, the control part 11 enables the first switching part 14, thereby allowing the remote telephone 6 to be connected to the PSTN 2. Thus, a remote telephone side user can easily use the remote telephone 6 without additional control.

Further, the remote power controller 10 includes a second switching part 15 controlling an electrical connection between the remote telephone 6 and the off-hook sensor 20. The second switching part 15 is enabled in the standby state for receiving the ring signal, thereby allowing the off-hook sensor 20 to sense that the remote telephone 6 is off the hook. When the off-hook sensor 20 determines that the remote telephone 6 is off the hook, the control part 11 disables the second switching part 15. When the on-hook sensor 19 senses that the remote telephone 6 is on the hook, the control part 11 enables the second switching part 15, thereby allowing the off-hook sensor 20 to determine that the remote telephone 6 is off the hook. Further, when the received caller ID is different from the predetermined ID, the second switching part 15 is disabled by the control part 11, thereby preventing the off-hook sensor 20 from sensing that the remote telephone 6 is off the hook. Hence, when the first switching part 14 is enabled by the control part 11 when the caller ID is different from the predetermined ID, the off-hook sensor 20 cannot sense that the remote telephone 6 is off-hook, thereby avoiding transmission of an overlapped signal enabling the first switching part 14 to the control part 11.

Further, the remote power controller 10 includes a ring signal cut-off part 16 to cut off the ring signal. The ring signal cut-off part 16 cuts off reception of the ring signal when the control part 11 determines that the caller ID is identical with the predetermined ID, thereby allowing the remote power controller 10 to receive another ring signal. At this time, a user, who reaches the remote telephone 6 by the local telephone 5 to turn on the remote computer system 4, can discover that the remote computer system 4 is enabled by the fact that the ring signal is cut off.

Further, the remote power controller 10 includes a connection ID generator 18 to generate a connection ID that is identical to the caller ID when the caller ID is different from the predetermined ID, and to transmit the connection ID to the remote telephone 6. Unlike the ring signal, the caller ID is generally received once at a first stage. Further, the caller ID is not transmitted to the remote telephone 6 because the first switching part 14 is disabled at the first stage. Hence, the connection ID generator 18 generates the connection ID that is identical to the caller ID when there is a telephone call to speak with a person and transmits the connection ID to the remote telephone 6, so that the remote telephone 6 can use the connection ID in ANI (automatic number identification), etc.

Further, the remote power controller 10 includes a signal reception detector 17 to detect reception of the caller ID and the ring signal and to transmit the caller ID and the ring signal to the control part 11. The signal reception detector 17 detects the caller ID and the ring signal received through the PSTN 2, and transmits them to the control part 11.

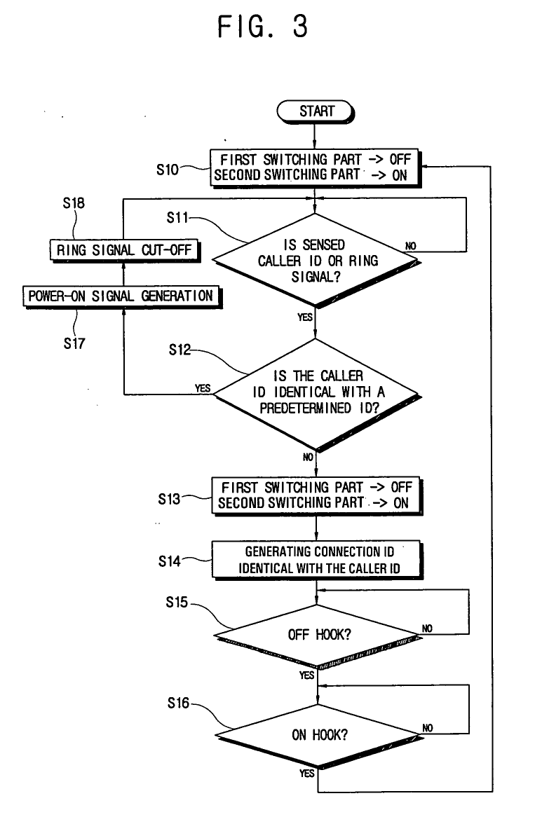

FIG. 3 is a control flowchart of the remote power controller 10 according to the present invention when the remote power controller 10 receives the caller ID and the ring signal through the PSTN 2. The operations of the remote power controller 10 will be described with reference to FIG. 3.

The first switching part 14 is disabled before receiving the caller ID and the ring signal, whereas the second switching part 15 is enabled (S10). The signal reception detector 17 detects whether the caller ID and the ring signal are received through the PSTN 2 (S11). When the signal reception detector 17 detects the caller ID and the ring signal, the signal reception detector 17 transmits the caller ID and the ring signal to the control part 11. The control part 11 determines whether the caller ID received through the PSTN 2 is identical to the predetermined ID stored in the memory 12 (S12). When the caller ID is identical to the predetermined ID, the power-on signal generator 13 generates the power-on signal and transmits the power-on signal to the remote computer 4 so as to enable the remote computer 4 (S17), and the control part 11 controls the ring signal cut-off part 16 to cut off the ring signal (S18).

When the caller ID is different from the predetermined ID, the control part 11 enables the first switching part 14 and disables the second switching part 15 (S13), so that the ring signal is transmitted to the remote telephone 6. Further, the connection ID that is generator 18 generates the connection ID identical to the caller ID and transmits the connection ID to the remote telephone 6 (S14). When the ring signal and the connection ID are transmitted to the remote telephone 6, the bell of the remote telephone 6 is rung. At this time, if a remote telephone side user picks up the receiver of the remote telephone 6, i.e., takes the remote telephone 6 off the hook (S15), the remote telephone side user can answer a telephone call of a local telephone side user. Thereafter, if the remote telephone side user hangs up the receiver of the remote telephone 6, i.e., places the remote telephone 6 back on the hook (S16), the on-hook sensor 19 determines that the remote telephone 6 is on the hook, so that the control part 11 disables the first switching part 14 and enables the second switching part 15, thereby returning the remote power controller 10 to the standby state for receiving the caller ID and the ring signal (S10).

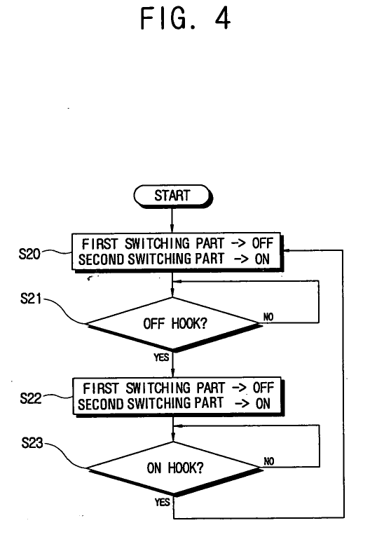

FIG. 4 is a control flowchart of the remote power controller 10 according to the present invention when the remote telephone side user picks up the receiver of the remote telephone 6. The operations of the remote power controller 10 will be described with reference to FIG. 4.

In the standby state before receiving the caller ID and the ring signal (S20), the remote telephone side user takes the remote telephone 6 off the hook. The off-hook sensor 20 determines that the remote telephone 6 is off the hook (S21), and transmits that determination to the control part 11, so that the control part 11 enables the first switching part 14 and disables the second switching part 15 (S22), thereby allowing the remote telephone side user to make a telephone call. Thereafter, when the remote telephone side user places the remote telephone 6 back on the hook, the on-hook sensor 19 determines that the remote telephone 6 is on the hook (S23), and transmits that determination to the control part 11, so that the control part 11 disables the first switching part 14 and enables the second switching part 15, thereby returning the remote power controller 10 to the standby state before receiving the caller ID and the ring signal (S20).

In the foregoing embodiment, to enable the remote computer system 4, a user reaches the remote telephone 6 through the PSTN 2 using the local telephone 5. However, to enable the remote computer system 4, a user reaches the remote telephone 5 through the Internet 1 connected to the PSTN 2 by the local computer 3 (refer to FIG. 1). Herein, there are various methods of connecting a user to the PSTN through the Internet, and their descriptions will be omitted because they are well known. In this case, the caller ID received by the remote power controller through the PSTN is a caller ID of an access server (not shown) connected to the local computer system.

As described above, the remote power controller according to the present invention can distinguish between a telephone call to speak with a person and a telephone call to enable an electronic device, so that only the bell of the remote telephone 6 is rung without enabling the remote computer system 4 when a user makes a telephone call to talk with a person, and only the remote computer system 4 is enabled without ringing the bell of the remote telephone 6 when a user makes a telephone call to enable the remote computer system 4.

As described above, the present invention provides a remote power controller and a method of controlling the same, which can distinguish between a telephone call to speak with a person and a telephone call to enable an electronic device.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although a few embodiments of the present invention have been shown and described, it will be appreciated by those skilled in the art that changes may be made in these embodiments without departing from the principles and spirit of the present invention, the scope of which is defined in the appended claims and their equivalents.

1. A remote power controller to enable an electronic device and usable with a PSTN (public switch telephone network), comprising:
a power-on signal generator, which is electrically connected to the electronic device, to generate a power-on signal to enable the electronic device; and
a control part to compare a caller ID (identification) with a predetermined ID when the caller ID and a ring signal are received through the PSTN, to control the power-on signal generator to generate the power-on signal when the caller ID is identical to the predetermined ID, and to control the ring signal to be transmitted to a telephone when the caller ID is different from the predetermined ID.

2. The remote power controller according to claim 1, further comprising a first switching part that is electrically connected to the telephone to control the ring signal being transmitted to the telephone.

3. The remote power controller according to claim 2, wherein the control part enables the first switching part when the caller ID is different from the predetermined ID.

4. The remote power controller according to claim 3, further comprising an on-hook sensor to determine whether the telephone is on-hook when the first switching part is enabled, and to transmit a first determination to the control part.

5. The remote power controller according to claim 4, further comprising:
an off-hook sensor to determine whether the telephone is off-hook and to transmit a second determination to the control part; and
a second switching part to open and close an electrical connection between the telephone and the off-hook sensor.

6. The remote power controller according to claim 5, wherein the control part enables the first switching part and disables the second switching part when the off-hook sensor determines that the telephone is off-hook.

7. The remote power controller according to claim 5, wherein the control part disables the first switching part and enables the second switching part when the on-hook sensor determines that the telephone is on-hook.

8. The remote power controller according to claim 1, further comprising a ring signal cut-off part that is controlled by the control part, to cut off reception of the ring signal when the caller ID is identical to the predetermined ID.

9. The remote power controller according to claim 1, further comprising a signal reception detector to detect reception of the caller ID and the ring signal, and to transmit the caller ID and the ring signal to the control part.

10. The remote power controller according to claim 1, further comprising a connection ID generator that is controlled by the control part, to generate a connection ID that is identical to the caller ID when the caller ID is different from the predetermined ID and to transmit the connection ID to the telephone.

11. A method of controlling a remote power controller to enable an electronic device and usable with a PSTN (public switched telephone network), comprising:
receiving a caller ID (identification) and a ring signal through the PSTN;
comparing the caller ID with a predetermined ID; and
controlling the electronic device to be enabled when the caller ID is identical to the predetermined ID, and controlling the ring signal to be transmitted to a telephone when the caller ID is different from the predetermined ID.

12. The method according to claim 11, wherein the controlling comprises cutting off reception of the ring signal when the caller ID is identical to the predetermined ID.

13. The method according to claim 11, wherein the controlling comprises generating a connection ID that is identical to the caller ID when the caller ID is different from the predetermined ID, and transmitting the connection ID to the telephone.

14. The method according to claim 11, wherein the controlling comprises preventing the ring signal from being transmitted to the telephone when the caller ID is identical to the predetermined ID.

15. The method according to claim 11, further comprising determining whether the telephone is on-hook, and
wherein the controlling comprises opening an electric connection between the telephone and the PSTN when the telephone is on-hook.

16. The method according to claim 13, further comprising:
determining whether the telephone is off the hook,
wherein the controlling comprises connecting the telephone to the PSTN when the telephone is off-hook.

17. The method according to claim 13, further comprising setting up the predetermined ID.

18. A system for distinguishing between a telephone call to initiate a conversation and a telephone call to enable an electronic device, comprising:
a remote electronic device;
a remote telephone;
a local telephone to call the remote telephone via a PSTN (public switched telephone network); and
a remote power controller to enable the remote electronic device or to ring the remote telephone based upon a comparison between a caller ID (identification) of the call from the local telephone and a predetermined ID.

19. The system of claim 18, further comprising:
a local computer to operate the remote electronic device.

20. The system of claim 18, wherein the remote power controller comprises:
a memory,
wherein the caller ID is a telephone number of the local telephone, and
wherein the predetermined ID is a telephone number that is stored in the memory.

21. The system of claim 18, wherein the remote power controller comprises:
a power-on signal generator to enable the remote electronic device;
a control unit to compare the caller ID to the predetermined ID, to control the power-on signal generator to generate and transmit a power-on signal to the remote electronic device when the caller ID and the predetermined ID are identical, and to transmit a ring signal to the remote telephone when the caller ID and the predetermined ID are not identical.

22. The system of claim 21, wherein the remote electronic device is enabled when the remote electronic device receives the power-on signal.

23. The system of claim 21, wherein the remote power controller further comprises:
an on-hook sensor to detect when the remote telephone is not being used;
a first switching unit to transmit the ring signal from the control unit to the remote telephone when the predetermined ID and the caller ID are identical and the remote telephone is not being used.

24. The system of claim 21, wherein the remote power controller further comprises:
a ring signal cut-off unit to cut off the ring signal when the caller ID is identical to the predetermined ID.

25. The system of claim 21, wherein the remote power controller further comprises:
a connection ID generator to generate a connection ID that is identical to the caller ID when the caller ID is not identical to the predetermined ID, and to transmit the connection ID to the remote telephone.

26. The system of claim 21, wherein the remote power controller further comprises:
a signal reception detector to detect the caller ID and the ring signal and to transmit the caller ID and the ring signal to the control unit.
